(19) United States
(12) Patent Application Publication
(10) Pub. No.: US 2004/0205635 A1
(43) Pub. Date: Oct. 14, 2004

(54) Displaying data base information as a document metaphor

(75) Inventor: Richard V. Pratte, Bedford, NH (US)

Correspondence Address: Bourque & Associates, P.A., Suite 301, 835 Hanover Street, Manchester, NH, 03104, US

(73) Assignee: Campagne Associates

(21) Appl. No.: 10/090,399

(22) Filed: Mar. 4, 2002

(51) Int. Cl. G06F 17/24

(52) U.S. Cl. 715/526; 715/500

(57) ABSTRACT

A data handler system which serves as an interface between a data display device and information store, such as a data base, retrieves information and displays it to the user in a form of a document metaphor. The document metaphor contains all of the information in a particular information record that a user desires to see. The user may scroll through the document metaphor, and may edit, save, print, and e-mail the document metaphor much the same as any other standard document. The document metaphor includes at least one expandable text box that grows and contracts, at least in one dimension, in accordance with the amount of text in the box. The document metaphor includes standard tool bars such as a menu bar, command bar, and navigation bar.

### TECHNICAL FIELD

The present invention relates to systems, methods, and computer programs for displaying data base type information as a textual document.

### BACKGROUND INFORMATION

Current data base applications present users with various tabbed windows, FIG. 1, to view and maintain data base information. These windows are “views” into the data base and divide up logical separations of information into various “tabs” in the user's window. Therefore, how the user views the data is also the same view presented to the user for entering or updating data.

Often times, the traditional data base presentation presents data as individual pieces of information, often times unconnected to one another. The view which the user must deal with is at the discretion of the data base interface programmer and often has no relationship to how the user needs to use or interact with the data base, thus presenting an unnatural and less useful interface for the user to the data base.

### SUMMARY

Accordingly, the present invention provides a data handler system which serves as an interface between a data display device and information store, such as a data base, and which retrieves information and displays it to the user in a form of a document metaphor. The document metaphor contains all of the information in a particular information record that a user desires to see. The user may scroll through the document metaphor, and may edit, save, print, and e-mail the document metaphor much the same as any other standard document. The document metaphor includes at least one expandable text box that grows and contracts, at least in one dimension, in accordance with the amount of text in the box. The document metaphor includes standard tool bars such as a menu bar, command bar, and navigation bar to facilitate the user's access to various section of the document metaphor and to other profiles or documents.

### BRIEF DESCRIPTION OF THE DRAWINGS

These and other features and advantages of the present invention will be better understood by reading the following detailed description, taken together with the drawings wherein:

FIG. 1 illustrates how a prior art data base is displayed to a user;

FIG. 2 is a block diagram of the system on which the present invention is implemented;

FIG. 3 is a document metaphor of the present invention showing a description of several metaphor sections;

FIG. 4 is a view of a document metaphor profile displayed in a view mode in accordance with the present invention;

FIG. 5 is a view of a document metaphor profile displayed in a data entry mode in accordance with the present invention;

FIG. 6 is a prior art text box;

FIGS. 7A and 7B are expandable text boxes in accordance with one feature of the present invention.

FIG. 8 illustrates a listing of multiple profiles of the same type of document metaphors in accordance with one aspect of the present invention;

FIGS. 9-14 illustrate various types of profiles displayed as document metaphors in accordance with the present invention; and

FIG. 15 is a list of multiple profiles of the same type in accordance with one feature of the present invention;

### DETAILED DESCRIPTION OF THE PREFERRED EMBODIMENT

The present invention features a data handler system 10 which serves as an interface between an information store 12, such as a data base and the display of information 14 on the user's computer display terminal 16. In the preferred embodiment, the present invention is implemented as computer software and thus, resides as a computer program on a storage medium, although this is not a limitation of the present invention. In addition, the code for such a computer program implementing the functions described herein is considered to be within the skill of someone of ordinary skill in the art after having read the present description.

In use, the data handler system 10 serves to initially retrieve information from the information store and display it as a document metaphor 14 on a computer display screen 16. A user may input his or her request using an input device such as a keyboard 18 and/or a mouse 20.

The data handler 10 manages the way information is recorded and stored in the database and how that information is displayed in a unified profile. The data handler 10 abstracts how the information is physically stored in the database by the use of the document metaphor.

A typical “main record” is comprised of multiple subsets of related information. Such as a person with multiple phone numbers; a customer and multiple invoices, an employee and multiple time slips. Profiles handle the plurality of related sub-set information to the main record by placing them one after the other in the profile sections (36) rather than in fixed “tabbed” windows. Again the amount of related sub-set information would cause the main profile record to be longer or shorter.

The data handler 10 manages all the various subsets of information of a main record into a profile while maximizing the need of the database system to handle the dataset as it requires.

The document for one record will expand and contract (lengthen/shorten) to account for the amount of information on that record. The data handler 10 positions the fields for the record one after the other (relative positioning) rather than in fixed positions on the window.

As shown herein, the data handler system 10 is resident on a computer system 22, which includes elements such as a central processor unit and memory, which are not shown, but are well known to those skilled in the art. The data handler system 10 need not reside on a user's computer system 22, but rather, may be stored and deployed remotely on an over network, although in such an embodiment it is contemplated that a copy of at least a portion of the data handler system would be resident on the local computer system 22. Additionally, the information stored 12 may also be located locally on computer system 22 or remotely, and accessed by the computer 22 over a network or other type of similar connection.

The document metaphor 14, FIG. 3, in accordance with the present invention, provides a visual presentation of information stored in the information storage 12 that is managed by the data handler system 10. Users of the present invention interact with the data stored in the information store through what appears to be a document 14. All of the information is displayed on the screen in the same way that any written text document would appear. A document will also be referred to as a profile in the present description. A profile is analogous to a main record in a traditional database application.

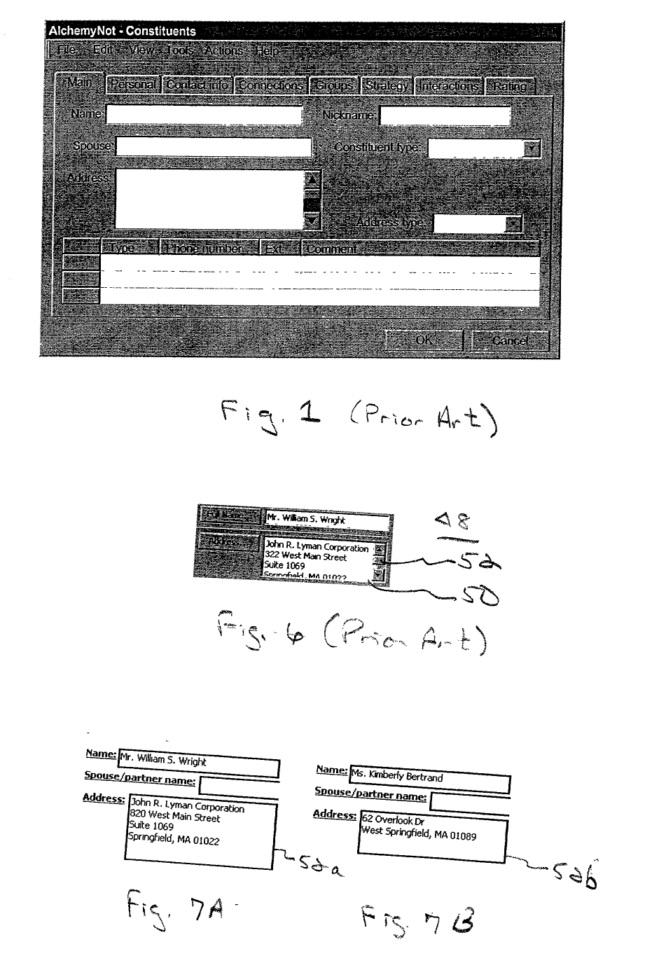

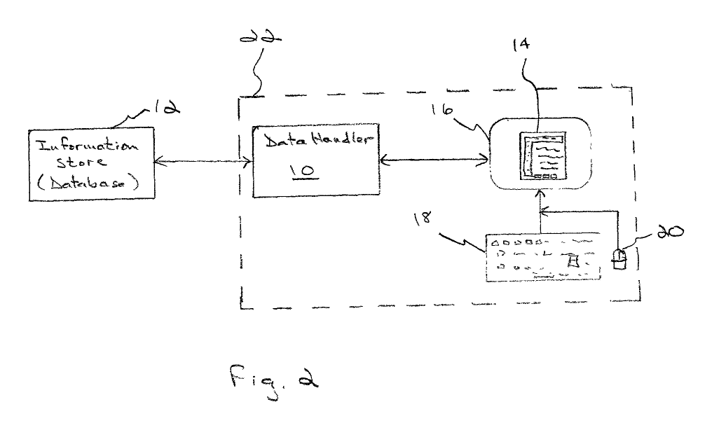

The system of the present invention is capable of maintaining a nearly unlimited number of profile types. Profiles may be manipulated, edited, printed, and e-mailed as maybe any other type of “document”. Because the “document” format is second nature to users, users will be more comfortable with the document metaphor 14 than a traditional data base presentation as shown in FIG. 1. A user will thus not have to learn a new programming language or adapt to a foreign environment in order to get the information that they need.

Each document metaphor 14 is shown as pages of information with a page header 24, and page footer 26. One instance of a piece of information retrieved from an information store is a profile. Multiple listings of profiles of the same type are called lists.

As the user views the document metaphor 14 (either a profile or a list), the user will have access to a command bar 28 having numerous commands which will be illustrated in greater detail below. The document metaphor will also include a navigation bar 30 and a menu bar 32. Such command bars, navigation bars, and menu bars are well known in the art. The information to be displayed by the document metaphor 14 will appear in the central region 34 of the document metaphor 14.

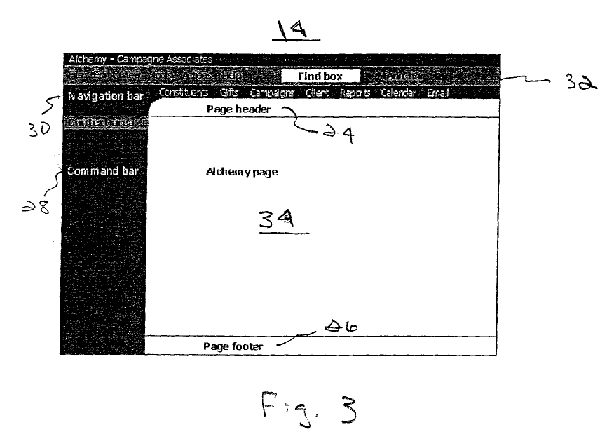

A document metaphor 14a, FIG. 4, will also include one or more sections such as section 36a-36d. Information in sections can be seen or hidden by expanding or contracting the section outline typically by clicking the appropriate section outline box 38.

When a user initially accesses a profile, they view it as they would any other computer-based document. The preferred embodiment of the present invention contemplates that a document profile 14a will initially be displayed in the “view” mode. In the view mode, some “fields” that appear separated in edit or data entry mode for ease of entry, are combined for ease of reading or viewing when in the view mode. For example, document metaphor 14a includes the address-type field 40 and the nickname field 42 displayed along with the address and name field 44, 46 respectively. When the document metaphor 14a, FIG. 5, is placed in the edit mode, it can be seen that the nickname field 42 is separated from the name field 46 while the address type field 40 is shown separated from the address field 44.

To toggle between data entry and view modes, a user merely utilizes a mouse or other similar device to “click” on the field and the profile changes form view mode to data entry mode or vice versa. The document metaphor 14a grows longer or gets shorter as a user adds or removes information. It is not a fixed length. If there is no information in a particular section, (as may be the case in most sections, at least initially), there isn't large blank blocks of space, but rather just a section header. In the preferred embodiment, the data handler places a check mark 48 next to “sections” 36 which contain information. Boxes 38 containing a “+” or a “−” sign indicated, as in many computer applications, whether that particular section is in the present state of expansion or is contracted.

Text boxes, such as address text box 44, which typically contain large blocks of variable length text, are variable in size in the present invention. A text field with a lot of text will take up more vertical space in the document metaphor than the same field with little or no data. However, it is a feature of the present invention that a user may always see and read all of the text in the field, no matter how much data is in the block and thus, a profile with a significant amount of text in the various sections would be longer than a profile with little or no text.

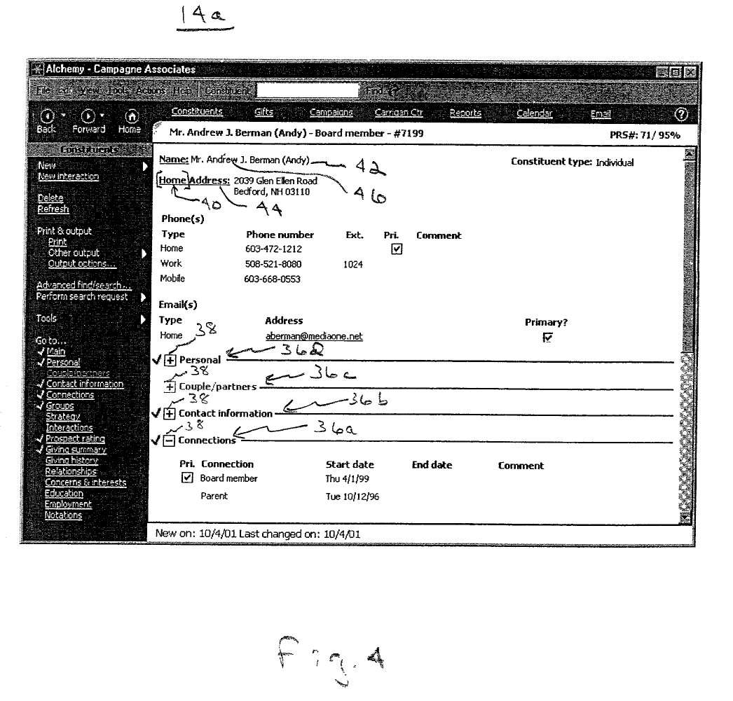

In the prior art, text boxes 48, FIG. 6, were displayed as a fixed sized box such as shown at 50 and thus, not all of he information in the section would be viable to the user without using the mouse to activate the scroll bar 52 to show the hidden data.

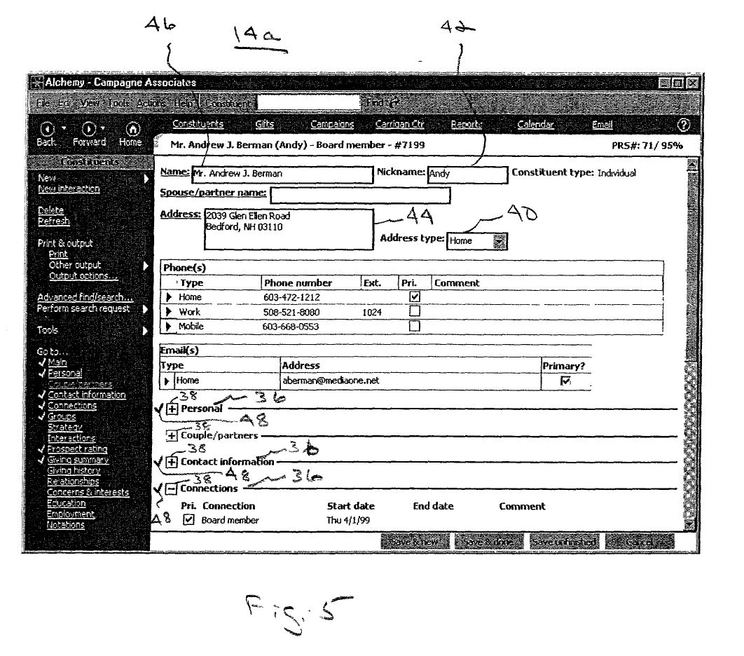

In contrast, one feature of the present invention is an expandable and contractible text box 52a and 52b, FIGS. 7A and 7B. As can be seen in address text box 52b, FIG. 7B, the address line contains only two lines of data and the text box 52b is significantly smaller than the text box 52a in which the address section contain four lines of data.

The feature of an expandable and contractible text box in accordance with the present invention is accomplished, in the preferred embodiment, by computer software. The computer program counts the keystrokes as the user is entering data and, using information as to the average width of a character, computes information on how much space is needed to display that amount of data, and expands the box as required to contain the size of text computer based on the number of characters entered. Thus, the “height” of the box typically expands relative to the amount of text in a box although the box could also expand in the horizontal direction.

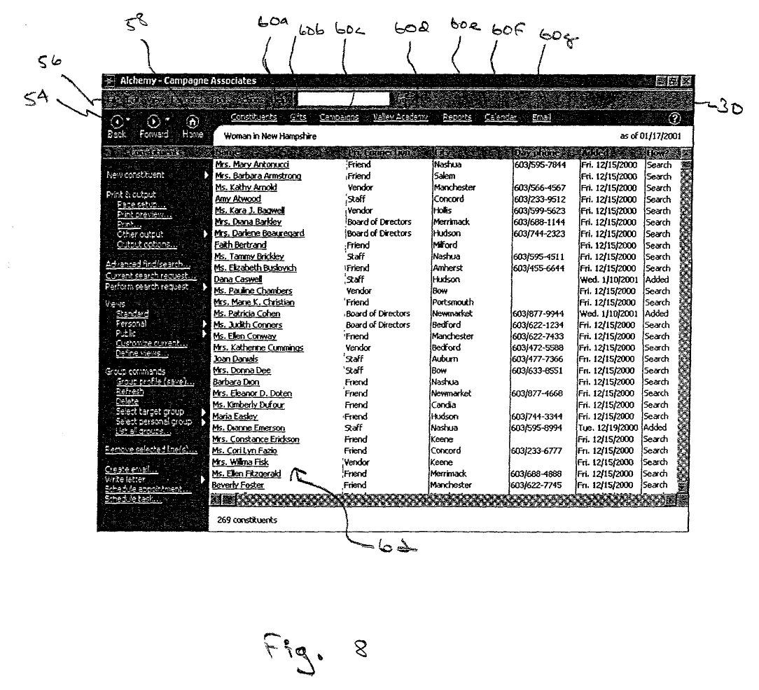

The navigation bar 30, FIG. 8, allows the user to navigate through the system including navigation actions with corresponding buttons such as back 54, forward 56, or home 58. In addition, the data handler 10 of the present invention displays the names of all the “profiles” 60 to which the user has access. Clicking on one of the profiles, such as profile 60a, displays a list 62 of all of the profile of that type. The user may then scroll up or down through the list and select one particular profile to view in detail.

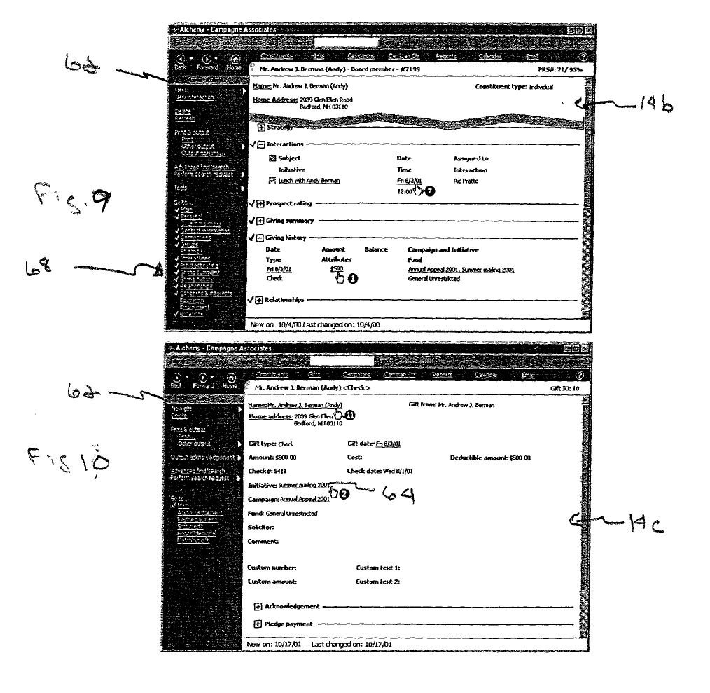

If a user were to select one profile from among the list of profiles 62, one document metaphor 14b, FIG. 9, would be displayed. A document metaphor includes a number of hyperlinks to other profiles to facilitate navigation through an information store. For example, if a user were to have a profile defined as a constituent or friend of a fund raising entity (this is used for illustrative purposes only and is not a limitation of the present invention), the user could select or click on the historical gift amount 1 to open the gift profile as document metaphor 14c, FIG. 10. The document metaphors of the present invention display the name of the profile as shown in status bar 62.

Once in the document metaphor 14c, a user may wish additional information on the “initiative” section 64 and may click on the initiative section, as shown at 2, to open the initiative profile as document metaphor 14d, FIG. 11.

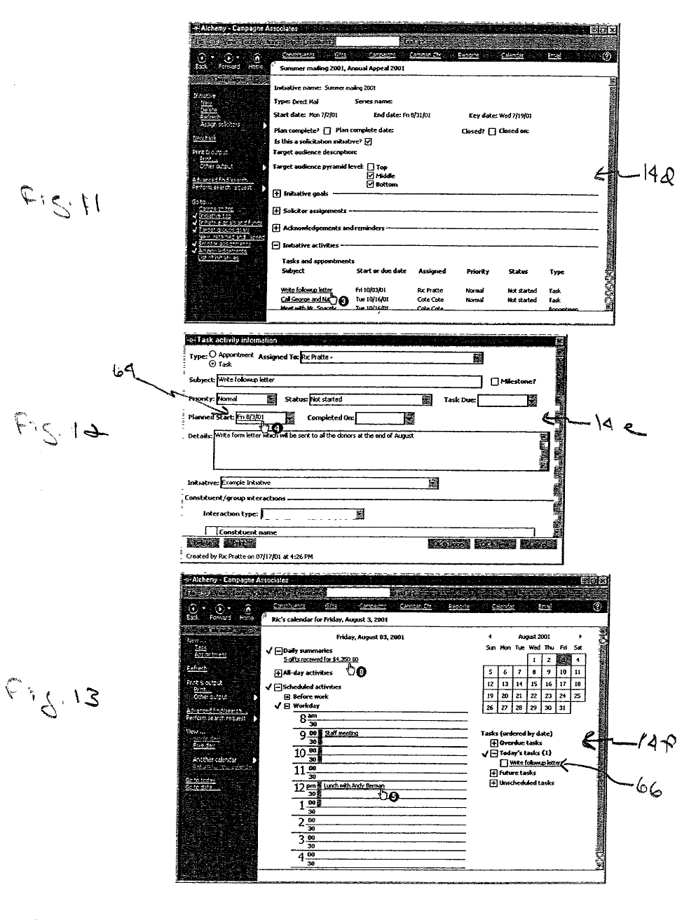

The initiative profile 14d includes a number of activities or tasks that the user has previously entered. The user may follow up on one or more of the activities by clicking on the activity as shown at 3 to open an activity information profile metaphor 14e, FIG. 12. Part of the document metaphor 14e is a planned start date for the task 64. If the user wishes to see what is on his or her calendar for that date, the user need only click on the date as shown at 4 to open the user's calendar metaphor 14f, FIG. 13. Entered in the user's calendar is the activity to perform 66 on that date.

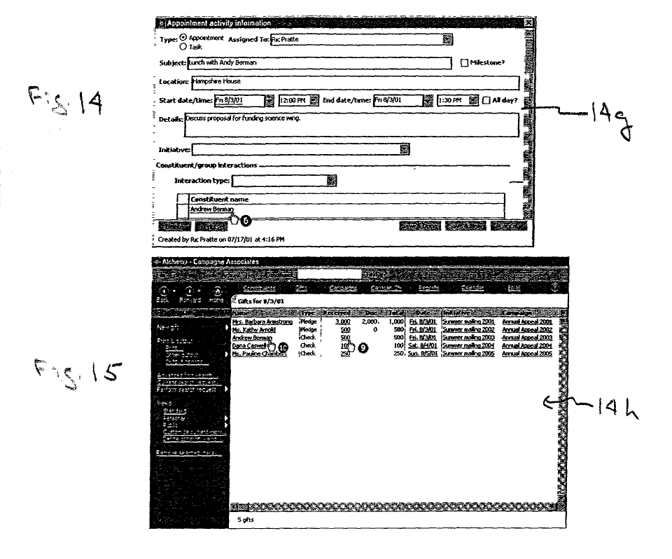

From the user's calendar, the user may click on one of the appointments such as shown in FIG. 5 to go to an appointment activity metaphor 14g, FIG. 14 to open the activity profile for that appointment. The user clicks on the name of the constituent or appointment as shown as 6, the data handler 10 of the present invention will return the user to the constituent profile or document metaphor 14b, FIG. 9. Access to the user's calendar document metaphor 14a, FIG. 13, may also be had by clicking on the date as shown at 7 in the document metaphor 14b, FIG. 9.

From the calendar metaphor 14f, FIG. 13, if the user wishes to review a daily summary of, for example, the number of gifts received by the organization, the user merely clicks in the daily summary of gift sections as shown at 8, which will bring up the gift document metaphor 14h, FIG. 15. Clicking on the gift amount received as shown at 9 will link the user back to the giving history section of document metaphor 14b, FIG. 9 while the constituent's profile may be opened from the gift list document metaphor 14h, FIG. 15, by clicking as shown at 10 to return to the constituent document metaphor 14b, FIG. 9.

Thus, as can clearly be seen by the previous example, much information in any one document metaphor is linked to other profiles and, ultimately, other document metaphors through one or more paths of displayed information.

Not all users want or need to deal with all of the information available within a particular profile. A given user may also have some information in a particular document metaphor that is more important than other information to them when performing a specific task. For example, management may not want a data entry person to have access to sensitive financial information or gift history when performing simple data entry tasks. Accordingly, the data handler of the present invention allows users to develop, name, and save profile views that can be recalled for later reuse.

Control of customization allows the user to define how the profile appears. The user can hide or show fields, skip field when tabbing, have default values pre-entered when adding a new profile, hide or show sections, or rearrange the order that the sections appear in the profile. The user accesses a profile customization document where they manipulate the attributes of the current profile. The customization document lists the section and fields as well as their controllable attributes (such as hide/show, display order, tab order, stop field, default values). The customization document can be named and saved for later use, thereby enabling a user to design and maintain a series of customized profiles that fit the need for different circumstances, all of which utilize the same basic dataset.

Control of what information appears in a particular document metaphor is done by the user selecting various sections from the command or tool bar 28, FIG. 3. For example, the selected or checked sections 68, FIG. 9, determine which sections of the profile are displayed.

The formatting of the lists 62, FIG. 8, may also be customized. The user may select which profiles appear in the list by processing each request and can define how the outcome appears. Users have control over which column (fields) appear, and where, as well as column width, column justification, as well as the column label/title. Users can also indicate how to sort the list. These customized list views can be created, names, and saved for later use. In addition, customized user views of profiles or lists may be saved for personal or public use. Thus, it is possible to have one set of information for public use and one set of information for private use by, for example, a manager.

Accordingly the present invention provides a unique document metaphor which is used to display information contained in an information store, such as a data base, in a format which is highly familiar to a user (in the form of a standard document) in which profile or document metaphor maybe viewed in its entirety by scrolling down through the document. The document maybe viewed in either edit or view mode to facilitate scrolling through the document. Finally, the present invention features a novel expandable text box, which is allowed to expand or contract in accordance with the amount of text that is contained within the box.

Modifications and substitutions by one of ordinary skill in the art are considered to be within the scope of the present invention, which is not to be limited except by the following claims.

The invention claimed is:

1. A system for use in presenting at least one record of information, including a plurality of fields of data, as a textual document that can be displayed and edited, said system comprising:
a data display device;
at least one data entry device;
an information store containing at least one data record; and
a data handler, coupled to said information store and to said data display device, for accessing said data base and for retrieving at least a portion of said at least one data record, said data handler for creating a document metaphor containing said at least a portion of said at least one retrieved data record for display on said data display device, said document metaphor allowing sequential viewing, on said data display device, of at least a portion of said retrieved data record as a text document.

2. The system of claim 1 wherein said document metaphor is viewable in its entirety by sequentially scrolling downward and upward through said document metaphor.

3. The system of claim 1 wherein said document metaphor includes a plurality of data record elements.

4. The system of claim 3 wherein said document metaphor includes a data entry view mode and a data display view mode.

5. The system of claim 4 wherein the view mode of a selected data record may be toggled between said data entry view mode and said data display view mode by signaling on said data record element by said at least one data entry device.

6. The system of claim 5 wherein said at least one data entry device includes a mouse, and wherein said signaling includes double-clicking on said selected data record element.

7. The system of claim 1 wherein said data base includes at least one record selected from at least one of the group of information stores consisting of an e-mail record data base, a calendar record data base; a report record data base; and a user defined record data base.

8. The system of claim 1 wherein said document metaphor includes at least one section, said at least one section including a plurality of data record elements.

9. The system of claim 8 wherein a users view of said at least one document metaphor section on said display device may be expanded and contracted.

10. The system of claim 1 wherein said document handler is responsive to a data record request input by a user on said at least one data entry device.

11. The system of claim 1 wherein said document metaphor includes a static header portion and a static footer portion.

12. The system of claim 1 wherein said document metaphor further includes at least one of a navigation bar and a command bar.

13. The system of claim 12 wherein said command bar includes a plurality of hyperlinks, each of said plurality of hyperlinks providing a direct access to a pre-determined section of said document metaphor.

14. The system of claim 7 wherein said document metaphor allows a user to move from one record of a first information store to another record.

15. The system of claim 14 wherein said one record in said first information store includes a hyperlink to said another record.

16. The system of claim 1 wherein said document metaphor is displayed as a web page.

17. The system of claim 16 wherein said document metaphor is displayed in HTML code.

18. The system of claim 1 wherein said document metaphor further includes at least one expandable text containing field which expands in size as more text is provided to be displayed in said field.

19. A computer program, residing in a storage medium, for use in presenting at least one record of information including a plurality of field of data as a textual document which can be displayed and edited, the program comprising executable instructions which enable a computer system to:
allow a user to select a record from an information store to be viewed;
retrieve at least a portion of the selected record;
present, on a data display device, at least a portion of the retrieved record as a document metaphor allowing sequentially viewing of the displayed portion of the record; and
allowing the user to switch the view of the document metaphor between a data entry view mode and a data display view mode.

20. The system of claim 19 wherein said document metaphor includes a data entry view mode and a data display view mode.

21. The system of claim 20 wherein the view mode of a selected data record maybe toggled between said data entry view mode and said data display view mode by signaling on said data record element by said at least one data entry device.

22. The system of claim 21 wherein said at least one data entry device includes a mouse, and wherein said signaling includes double-clicking on said selected data record element.

23. The system of claim 19 wherein said data base includes at least one record selected from at least one of the group of information stores consisting of an e-mail record information store, a calendar record information store; a report record information store; and a user defined record information store.

24. The system of claim 19 wherein said document metaphor includes at least one section, said at least one section including a plurality of data record elements.

25. The system of claim 24 wherein a users view of said at least one document metaphor section on said display device may be expanded and contracted.

26. The system of claim 19 wherein said document handler is responsive to a data record request input by a user on said at least one data entry device.

27. The system of claim 19 wherein said document metaphor includes a static header portion and a static footer portion.

28. The system of claim 19 wherein said document metaphor further includes at least one of a navigation bar and a command bar.

29. The system of claim 28 wherein said command bar includes a plurality of hyperlinks, each of said plurality of hyperlinks providing a direct access to a pre-determined section of said document metaphor.

30. The system of claim 23 wherein said document metaphor allows a user to move from one record of a first information store to another record.

31. The system of claim 30 wherein said one record in said first information store includes a hyperlink to said another record.

32. The system of claim 19 wherein said document metaphor is displayed as a web page.

33. The system of claim 32 wherein said document metaphor is displayed in HTML code.

34. The system of claim 19 wherein said document metaphor further includes at least one expandable text containing field which expands in size as more text is provided to be displayed in said field.

35. A method for presenting at least one record of information including a plurality of fields of data as a textual document which can be displayed and edited, said method comprising the acts of:
providing a data handler, responsive, in use, to at least one information store containing at least one data record;
responsive, in use, to a user request for access to at least a portion of at least one record, accessing said information store and retrieving at least a portion of said at least one data record; and
responsive to said accessing and retrieving, creating a document metaphor allowing sew viewing of at least a portion of said retrieved data record on said data display device as a textual document.
